(19) United States
(12) Patent Application Publication
(10) Pub. No.: US 2004/0000213 A1
(43) Pub. Date: Jan. 1, 2004

(54) Camshaft

(76) Inventors: Toshikazu Hamamoto, Saitama (JP); Yoshiki Suzuki, Saitama (JP); Chutaro Kobayashi, Saitama (JP)

Correspondence Address: BIRCH STEWART KOLASCH & BIRCH, PO BOX 747, FALLS CHURCH, VA, 22040-0747, US

(21) Appl. No.: 10/401,783

(22) Filed: Mar. 31, 2003

(30) Foreign Application Priority Data
Jun. 28, 2002 (JP) 2002-190671

(51) Int. Cl. F16H 53/00

(52) U.S. Cl. 74/567

(57) ABSTRACT

A camshaft formed by integrating at least a bearing cylindrical member and a cam piece with a shaft of steel pipe by wax binding. The cam piece is cast iron where a chilled layer is formed. Wax material used in the wax bonding is silver solder. A predetermined portion of the cam piece is nickel-plated. Abrasion of a slide surface of the valve lifter as a counterpart in sliding of the cam piece can be prevented. Thus, the manufacturing cost of the valve lifter can be suppressed by employing a general material as the valve lifter. As the cam piece is a cast product, the productivity of the cam piece can be improved. The manufacturing cost of the valve lifter can be suppressed, and at the same time, the weight of the camshaft can be reduced and the manufacturing cost of the camshaft can be reduced.

### CROSS-REFERENCE TO RELATED APPLICATIONS

The present nonprovisional application claims priority under 35 USC 119 to Japanese Patent Application No. 2002-190671 filed on Jun. 28, 2002 the entire contents thereof is hereby incorporated by reference.

### BACKGROUND OF THE INVENTION

1. Field of the Invention

The present invention relates to a camshaft where a constituent part such as a cam is integrated with a shaft by wax bonding.

2. Description of Background Art

Camshafts, cast products, forged products and assembled products are known. A cast product is disclosed in Japanese Published Examined Patent Application No. Sho 63-30099 entitled “Camshaft Mold Manufacturing Method.” A description will be made with respect to FIG. 8 which is an explanatory view of a conventional cast camshaft. FIG. 8 set forth in the present specification corresponds to FIG. 4 in the above publication, showing a camshaft manufactured by using the camshaft mold manufacturing method.

A camshaft 1 with a solid-core (solid) shaft 5, cams 3 and 4, and a journal 2 are integrally molded.

A forged product is made by integrally forming a solid-core (solid) shaft, a cam and a journal by forging. Further, surface finishing is performed on the product so as to improve its mechanical characteristic.

An assembled product is made by press-fitting a cam piece to a shaft or by shrinkage-fitting or wax-bonding a cam piece to a steel pipe. A wax-bonded product is disclosed in Japanese Published Examined Patent Application No. Sho 57-36460 entitled “Camshaft Manufacturing Method.” A description will be made with respect to FIG. 9 which is an explanatory view of conventional assembled camshaft. FIG. 9 of the present specification corresponds to FIG. 4 of the above publication and illustrates a camshaft manufactured by using the camshaft manufacturing method.

A camshaft assembly A is made by wax-bonding a cam piece 2 of sintered material to a stem 1 formed of a steel pipe.

As the cast camshaft in the above FIG. 8 is heavy, it cannot respond to expectations for the need for an improvement in fuel consumption by reducing the weight of the motorcycles.

As the forged camshaft has a higher mechanical characteristic in comparison with the cast product, its weight can be reduced by reducing the thickness. However, the manufacturing cost increases.

Further, in the case of a surface-finished forged camshaft, as an expensive material with excellent abrasion resistance must be employed as a valve lifter, the manufacturing cost further increases.

In the assembled camshaft illustrated in FIG. 9, as a sintered cam piece is employed, it takes much time and trouble in manufacturing the material prior to sintering, and the manufacturing cost is high.

### SUMMARY AND OBJECTS OF THE INVENTION

Accordingly, it is an object of the present invention to provide a camshaft at a reduced manufacturing cost by suppressing the manufacturing cost of valve lifter and at the same time achieving a weight reduction.

To attain the foregoing object, a camshaft is provided in which at least a bearing cylindrical member and a cam piece are integrated with a shaft of steel pipe by wax bonding, wherein said cam piece is cast iron on which a chilled layer is formed.

As the cam piece is cast iron where a chilled layer is formed, abrasion of a slide surface of the valve lifter as a counterpart member in sliding of the cam piece can be prevented. As a result, a general material can be employed as the valve lifter, and the manufacturing cost of the valve lifter can be suppressed. Further, as the cam piece is a cast product, the productivity of the cam piece can be improved, on the other hand, the manufacturing cost can be reduced by using the shaft of steel pipe.

That is, the manufacturing cost of the valve lifter is suppressed, and at the same time, the weight of the camshaft is reduced and the manufacturing cost of the camshaft is reduced.

According to the present invention, the wax material used in the wax bonding is silver solder.

In use of silver solder, even if heat is conducted from the silver solder at a wax-bonding temperature to the cam piece, the temperature of the chilled layer of the cam piece does not rise to a temperature region to degrade the hardness of the chilled layer.

According to the present invention, a predetermined portion of the cam piece is nickel-plated.

The predetermined portion is in a range corresponding to a wax-bonded portion. When the portion is nickel-plated, graphite of cast iron which is a factor to degrade the wettability upon wax bonding can be covered with the film of nickel plating, thus the wettability upon wax bonding of the cam piece can be improved.

According to present invention, the nickel plating is electroless plating.

As electroless plating is employed, the thickness of plating is approximately uniform along a hole of the cam piece and the edge of the hole. Thus, a phenomenon wherein the thickness of nickel plating formed along the edge increases can be suppressed.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 a cross-sectional view of valve mechanism of an internal combustion engine using the camshaft according to the present invention;

FIG. 2 a perspective view of the camshaft according to the present invention;

FIG. 3 a cross-sectional view along the line 3-3 in FIG. 2;

FIG. 4 a cross-sectional view along the line 4-4 in FIG. 2;

FIG. 5 a detailed view of part 5 in FIG. 3;

FIG. 6 an explanatory view of the camshaft manufacturing method according to the present invention;

FIG. 7 a diagram of the other working example;

FIG. 8 an explanatory view of the conventional cast camshaft; and

FIG. 9 an explanatory view of the conventional assembled camshaft.

### DETAILED DESCRIPTION OF THE PREFERRED EMBODIMENTS

A working example of the present invention will be described in accordance with the attached drawings. Note that the figures are to be viewed along the direction of reference numerals.

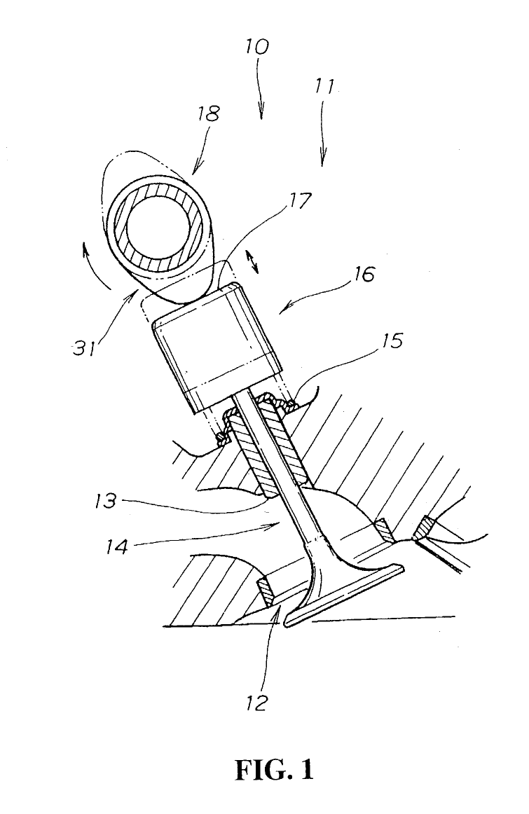

FIG. 1 is a cross-sectional view of valve mechanism of an internal combustion engine using a camshaft according to the present invention. A valve mechanism 10 has a valve seat 12 provided in a lower part of cylinder head 11 of the internal combustion engine with an intake valve 14 being attached to the cylinder head 11 via a valve guide 13. A valve spring 15 is provided above the intake valve 14 with a valve lifter 16 (slide surface 17), and a camshaft 18 for air intake, rotatably attached to the cylinder head 11 so as to actuate the intake valve 14 with the valve lifter 16.

Next, the camshaft 18 will be described.

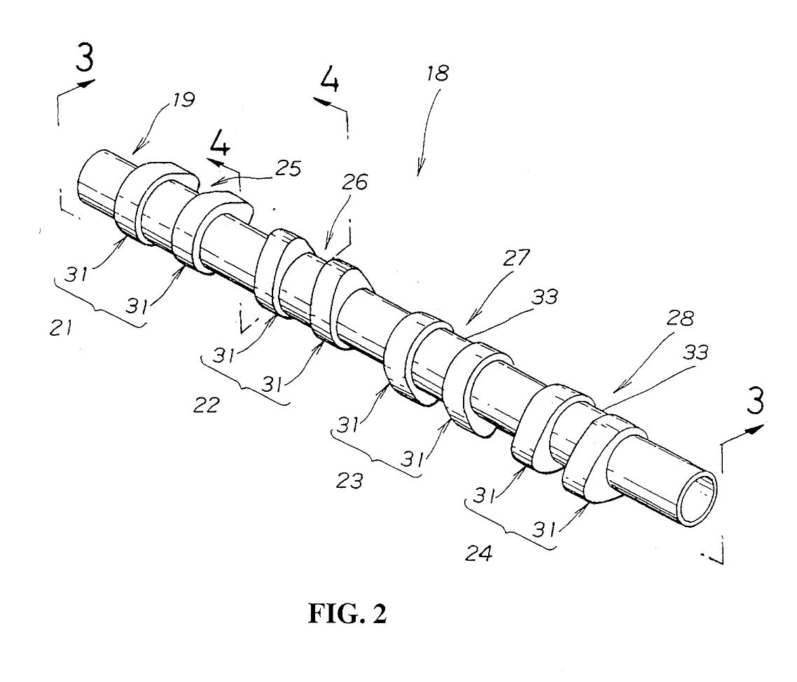

FIG. 2 is a perspective view of a camshaft according to the present invention. The camshaft 18 is made by attaching first, second, third, fourth cams 21, 22, 23 and 24, and first, second, third and fourth journals 25, 26, 27 and 28, to a shaft 19.

Only the first to fourth cams 21 to 24 and the first to fourth journals 25 to 28 are formed here. However, parts such as a cam flange not shown in FIG. 2 are attached in accordance with necessity.

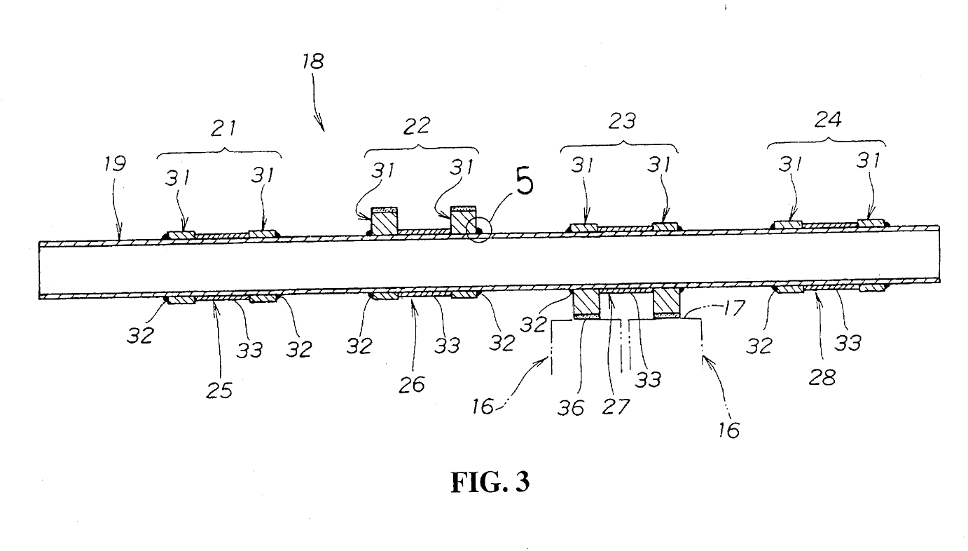

FIG. 3 is a cross-sectional view cut along a line 3-3 in FIG. 2, showing a state where the first, second, third and fourth cams 21, 22, 23 and 24, and the first, second, third and fourth journals 25, 26, 27 and 28 are attached to the shaft 19.

The material of the shaft 19 is a steel pipe. For example, a carbon steel pipe for the mechanical structure (symbol: STKM) is employed.

The first cam 21 is attached by fitting cam pieces 31, 31 in predetermined positions on the shaft 19 and wax-bonding the entire perimeters with wax material 32.

The second to fourth cams 22 to 24 are attached as in the case of the first cam 21. Therefore, an explanation thereof will be omitted.

The first journal 25 is attached by fitting a bearing cylindrical member 33 on the shaft 19, and positioning and fixing both ends of the bearing cylindrical member 33 with the cam pieces 31, 31.

The inner diameter of the bearing cylindrical member 33 is set so as to attain a predetermined engagement with the shaft 19.

The material of the bearing cylindrical member 33 is steel. For example, hard steel (e.g., symbol: S45C) or carbon steel pipe for the mechanical structure (symbol: STKM) is employed.

The second to fourth journals 26 to 28 are attached as in the case of the first journal 25. Therefore, an explanation thereof will be omitted.

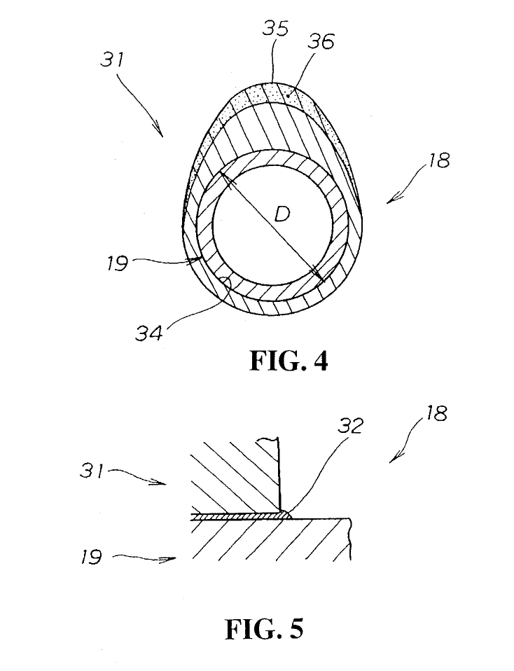

FIG. 4 is a cross-sectional view cut along a line 4-4 in FIG. 2, showing a cross section of the cam piece 31.

The cam piece 31 is made by forming a hole 34 with a diameter D to engage with the shaft 19 at the center, and forming a peak member 35 to slide against the valve lifter 16 (See FIG. 1) in the rim of the cam piece.

The material of the cam piece 31 is cast iron, and a chilled layer 36 is formed on the peak member 35.

The diameter D of the hole 34 of the cam piece 31 is set with a predetermined dimensional tolerance for predetermined engagement.

FIG. 5 is a detailed view of part 5 in FIG. 3 schematically showing a state where the cam piece 31 is wax-bonded to the shaft 19 with the wax material 32.

The type of the wax material 32 is silver solder. The components of the silver solder are arbitrary. However, the components are selected based on e.g. a wax bonding temperature.

Note that the schematic view of FIG. 5 shows an example of engagement between the shaft 19 and the cam piece 31 and shows a clearance. However, the presence/absence of a clearance and the value of the clearance are arbitrary.

Next, an example of a manufacturing method of the camshaft 18 according to the present invention will be described.

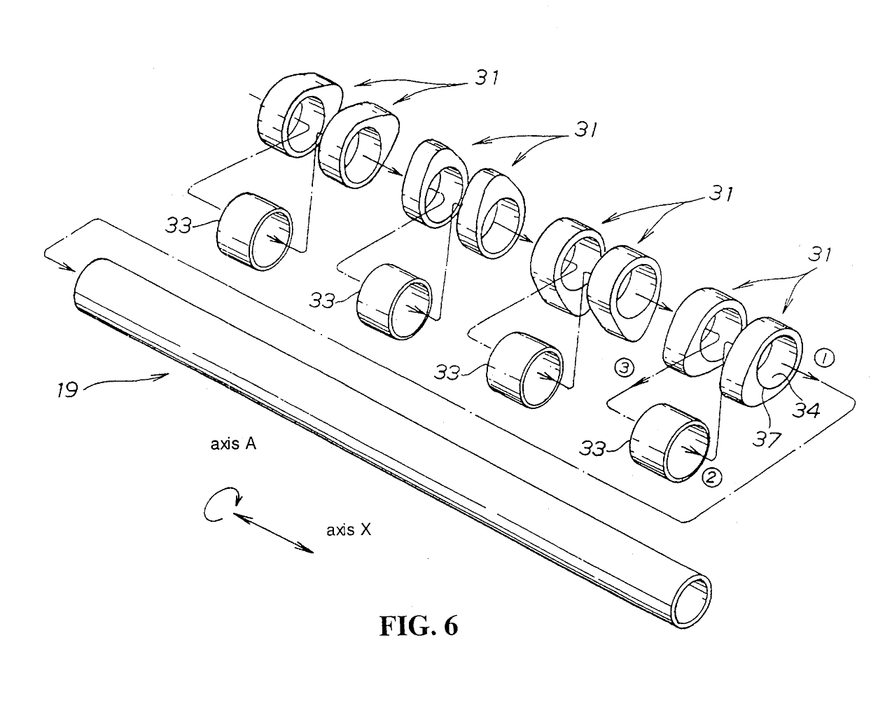

FIG. 6 is an explanatory view of the camshaft manufacturing method according to the present invention.

First, the shaft 19 is formed. Here a shaft material member (not shown) having inner and outer diameters of predetermined dimensions by drawing is employed, and desired shapes are formed by using an NC lathe on inner and outer surfaces and both ends of the shaft, thereby the shaft 19 is obtained.

Next, the cam piece 31 is prepared. The cam piece 31 is obtained by machining a previously-molded cam piece material (not shown) to a predetermined dimension.

Then, the shaft 19 is attached to an assembling tool (not shown), the cam piece 31 is put on the shaft 19 as indicated by an arrow and the cam piece 31 is brought into contact with a stopper of the assembling tool. Thereby, the positioning with a position along the axis X direction and angle in the axis A direction is made.

Then, the bearing cylindrical member 33 is put on the shaft 19 as indicated by an arrow. Further, the cam piece 31 is positioned as indicated by an arrow thus holding the bearing cylindrical member 33 therebetween. Thereby, the positioning with a position in the axis X direction is performed and positioning of the cam piece 31 with an angle in the axis A direction is performed by the stopper of the assembling tool.

Similarly, the remaining 6 cam pieces 31 . . . ( . . . represents a plural form. Hereinbelow, the same symbol will be used in the same representation) and the remaining 3 bearing cylindrical member 33 . . . are positioned. Then edges 37 of the holes 34 of the cam pieces 31 are tack-welded (by e.g. TIG welding) thereby a temporary fixing is performed. Finally, the entire perimeters of the edges 37 of the cam pieces 31 are wax-bonded on a desired condition (device, flux or the like), thus the wax bonding process of the cam piece 31 is completed.

The bearing cylindrical member 33 is not wax-bonded here but both ends of the bearing cylindrical member 33 are pressed by the cam pieces 31, 31, thereby the bearing cylindrical member 33 is fixed.

In a case where a lubricating oil channel is formed in the bearing cylindrical member 33 or in a case where an unshown part such as a cam flange is finish-processed, such processes are performed after the wax bonding process.

The operation of the above-described camshaft will be described next.

As shown in FIG. 3, as the cam piece 31 joined to the shaft 19 of steel pipe is cast iron where a chilled layer 36 is formed, the thickness of the camshaft 18 can be reduced, and at the same time, abrasion of the slide surface 17 of the valve lifter 16 as a counterpart in sliding of the cam piece 31 can be prevented. The manufacturing cost of the valve lifter 16 can be suppressed by employing a general material as the valve lifter 16.

Further, as the cam piece 31 is wax-bonded to the steel pipe shaft 19, the thickness of the camshaft 18 can be reduced, and the weight of the camshaft 18 can be reduced.

As the shaft 19 comprises a steel pipe, trouble upon manufacturing of the shaft 19 having a small thickness can be omitted, and the manufacturing cost can be reduced.

As the cam piece 31 is a cast product, the productivity of the cam piece 31 can be improved.

Accordingly, the manufacturing cost of the valve lifter 16 can be suppressed, and at the same time, the weight of the camshaft 18 can be reduced and the manufacturing cost of the camshaft 18 can be reduced.

As the wax material 32 used in wax bonding of the cam piece 31 is silver solder, even if heat is conducted from the silver solder at a wax-bonding temperature to the cam piece 31, the temperature of the chilled layer 36 of the cam piece 31 does not rise to a temperature region to degrade the hardness of the chilled layer 36, thus the mechanical characteristic of the chilled layer 36 can be maintained.

As the bearing cylindrical member 33 is joined to the shaft 19, only the first to fourth journals 25 to 28 of the camshaft 18 receiving a high stress are thick. Thus, the weight reduction can be achieved while the strength of the camshaft 18 can be ensured.

Further, as the bearing cylindrical member 33 is joined to the shaft 19, a different material can be employed as the first to fourth journals 25 to 28. As a result, a material having more excellent mechanical characteristic can be employed, and the weight of the camshaft 18 can be further reduced.

Next, another working example of the camshaft according to the present invention will be described.

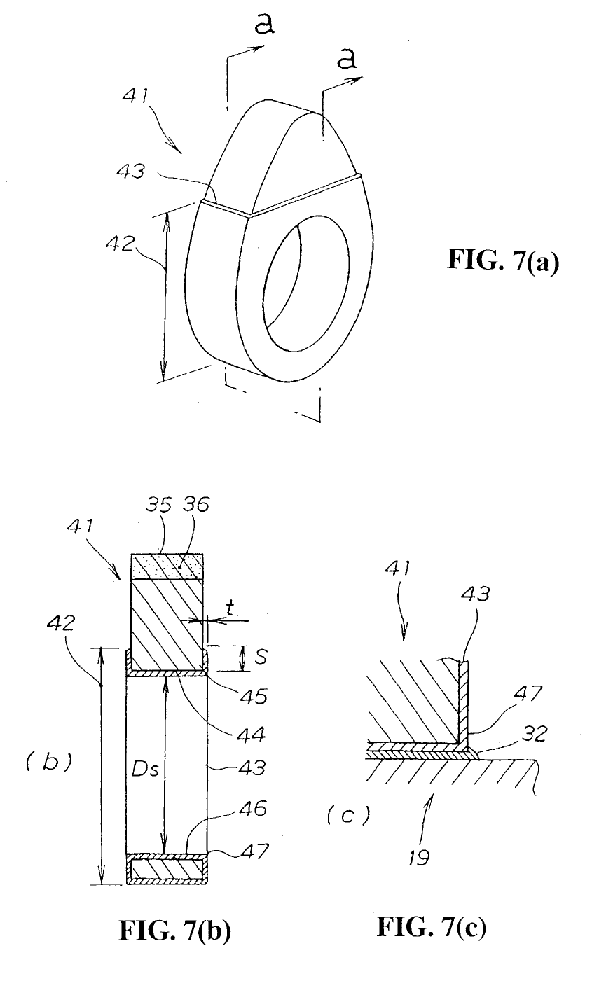

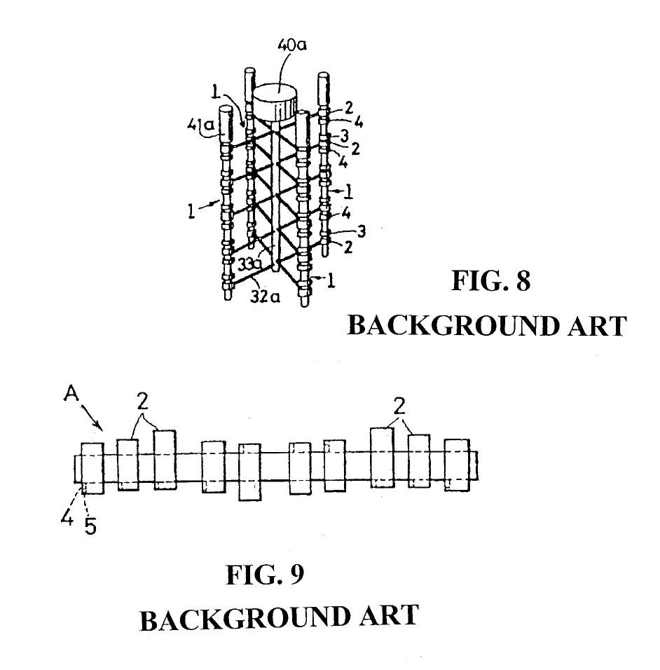

FIGS. 7(a) to 7(c) are diagrams showing another working example. FIG. 7(a) is a perspective view of the cam piece; FIG. 7(b), a cross-sectional view along a line a-a in FIG. 7(a); and FIG. 7(c), a diagram corresponding to the detailed view of part 5 in FIG. 3. Elements corresponding to those in the working example shown in the above FIG. 3 have the same reference numerals, and explanations thereof will be omitted.

In FIG. 7(a), a cam piece 41 of the other working example is characterized in that a predetermined portion 42 is coated with a nickel plating (film) 43.

In FIG. 7(b), the predetermined portion 42 is a plating range, i.e., a range equal to or shorter than a distance S from a hole 44 and an edge 45 of the hole 44.

The nickel plating 43 is electroless plating, and the thickness of plating is set to t. A hole 46 is coated with the nickel plating 43 with an edge 47 coated with the nickel plating 43. In addition, a diameter Ds of the hole is coated with the nickel plating 43.

In FIG. 7(c), the entire perimeter of the edge 47 of the cam piece 41 is wax-bonded to the shaft 19 with wax material 32.

Next, the operation of the other working example will be described.

As the predetermined portion 42 of the cam piece 41 is coated with the nickel plating 43, graphite of cast iron which is a factor to degrade the wettability upon wax bonding can be covered with the film of nickel plating 43. Thus, the wettability upon wax bonding of the cast iron can be improved. Accordingly, the strength of wax bonding can be increased.

The nickel plating 43 is formed by electroplating (electric processing) or electroless plating (chemical processing). If the predetermined portion 42 of the cam piece 41 is nickel-plated by electroplating, the range of variation in the thickness of plating is wide. More particularly, the film deposited along the edge 45 of the hole 44 is thick. As a result, the range of variation in dimension of the nickel-plated hole is wide.

As the nickel plating 43 is formed by electroless plating, the thickness of the plating t is approximately uniform along the hole 44 of the cam piece 41 as a parent material and the edge 45 of the hole 44, and a phenomenon wherein the nickel plating 43 formed on the edge 45 locally grows and the thickness of plating increases can be suppressed. As a result, the roundness of the diameter Ds of the plated hole 46 can be ensured. Thus, an adjustment after the coating with the nickel plating 43 can be omitted and the manufacturing efficiency can be improved.

Note that it may be arranged such that a concave or convex portion as a rotation-stopper may be formed on the outer surface of the shaft 19 shown in the working example of the present invention. In addition, a concave or convex member to engage with the concave or convex portion is formed on the hole 34 of the cam piece 31.

The cam piece 31 is cast iron and the chilled layer 36 is formed. However, the material and processing of characteristic of the cam piece 31 are arbitrary.

In the valve mechanism 10, an air intake system (the intake valve 14 and the air intake camshaft 18) is shown, however, an exhaust system (an exhaust valve and an exhaust camshaft) may be shown.

The present invention exerts the following effects by the above construction.

In the present invention, as a camshaft is made by integrating at least a bearing cylindrical member and a cam piece with a shaft of steel pipe by wax bonding, and the cam piece is cast iron on which a chilled layer is formed, abrasion of the slide surface of the valve lifter as a counter part in the sliding of the cam piece can be prevented. The manufacturing cost of the valve lifter can be suppressed by employing a general material as the valve lifter. Further, as the cam piece is a cast product, the productivity of the cam piece can be improved. That is, the manufacturing cost of the valve lifter can be suppressed, and at the same time, the weight of the camshaft can be reduced and the manufacturing cost of the camshaft can be reduced.

In the present invention, as the wax material used in the wax bonding is silver solder, even if heat is conducted from the silver solder at a wax-bonding temperature to the cam piece, the temperature of the chilled layer of the cam piece does not rise to a temperature region to degrade the hardness of the chilled layer. Thus, the mechanical characteristic of the chilled layer can be maintained.

In the present invention, as the predetermined portion of the cam piece is nickel-plated, graphite of cast iron which is a factor to degrade the wettability upon wax bonding can be covered with the film of nickel plating. Thus, the wettability upon wax bonding of the cast iron can be improved. Accordingly, the strength of wax bonding can be increased.

In the present invention, as the nickel plating is electroless plating, the thickness of plating is approximately uniform along the hole of the cam piece and the edge of the hole, and a phenomenon wherein the nickel plating formed on the edge locally grows and the thickness of the plating increases can be suppressed. As a result, the roundness of the diameter of the plated hole can be ensured. Thus, an adjustment after coating with the nickel plating can be omitted and the manufacturing efficiency can be improved.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A camshaft comprising:
at least a bearing cylindrical member and a cam piece are integrated with a shaft of steel pipe by wax bonding;
said cam piece being made of cast iron on which a chilled layer is formed.

2. The camshaft according to claim 1, wherein wax material used in said wax bonding is silver solder.

3. The camshaft according to claim 1, wherein a predetermined portion of said cam piece is nickel-plated.

4. The camshaft according to claim 3, wherein said nickel plating is electroless plating.

5. The camshaft according to claim 1, wherein the bearing cylindrical member is constructed of steel.

6. The camshaft according to claim 5, wherein said bearing cylindrical member is constructed of hard steel.

7. The camshaft according to claim 5, wherein said bearing cylindrical member is constructed of carbon steel.

8. The camshaft according to claim 1, wherein a clearance is provided between said cam piece and said shaft and said wax bonded is formed on an edge of said cam piece in said clearance.

9. The camshaft according to claim 3, wherein said predetermined portion of said cam piece that is nickel-plated is an aperture portion for mounting on said shaft.

10. A camshaft comprising:
a first cam piece;
at least one bearing member; and
a second cam piece;
said first cam piece and said second cam piece being wax bonding on a shaft with said at least one bearing member being positioned therebetween;
said first and second cam pieces being made of cast iron.

11. The camshaft according to claim 10, wherein wax material used in said wax bonding is silver solder.

12. The camshaft according to claim 10, wherein a predetermined portion of said first and second cam pieces are nickel-plated.

13. The camshaft according to claim 12, wherein said nickel plating is electroless plating.

14. The camshaft according to claim 10, wherein the at least one bearing member is constructed of steel.

15. The camshaft according to claim 14, wherein said at least one bearing member is constructed of hard steel.

16. The camshaft according to claim 14, wherein said at least one bearing member is constructed of carbon steel.

17. The camshaft according to claim 10, wherein a clearance is provided between said first and second cam pieces and said shaft and said wax bonded is formed on an edge of said first and second cam pieces in said clearance.

18. The camshaft according to claim 3, wherein said predetermined portion of said first and second cam pieces that is nickel-plated is an aperture portion for mounting on said shaft.
